(19) United States
(12) Patent Application Publication
(10) Pub. No.: US 2006/0286426 A1
(43) Pub. Date: Dec. 21, 2006

(54) Fuel cell, fuel cell stack, and fuel cell system

(75) Inventors: Tetsuro Kikuchi, Okazaki-shi (JP); Hiroyuki Usami, Kariya-shi (JP); Hiroyasu Kudo, Iwakura-shi (JP); Yuichi Sakajo, Okazaki-shi (JP)

Correspondence Address: OLIFF & BERRIDGE, PLC, P.O. BOX 19928, ALEXANDRIA, VA, 22320, US

(73) Assignee: DENSO CORPORATION, Kariya-city (JP)

(21) Appl. No.: 11/446,161

(22) Filed: Jun. 5, 2006

(30) Foreign Application Priority Data
Jun. 15, 2005 (JP) 2005-174987

(51) Int. Cl. H01M 8/02; H01M 8/10; H01M 4/94; H01M 8/24

(52) U.S. Cl. 429/34; 429/32; 429/44; 429/38; 429/37

(57) ABSTRACT

A fuel cell stack has plural fuel cells stacked in series along a direction vertical to a main surface of each fuel cell. Each fuel cell has a lamination body made of an anode, a cathode, and a polymer proton exchange membrane. The lamination body is sandwiched between a pair of separators. Each of the anode and cathode has a catalyst layer and a diffusion layer laminated. A water collecting groove and fuel gas passages are formed in the inner surface of each separator. The bottom end of the water collection groove is lower in position than the end of the catalyst layer and the diffusion layer. The water collecting groove is not joined to the fuel gas passages and collects water produced by electrochemical reaction in each fuel cell, and drains the collected water.

### CROSS-REFERENCE TO RELATED APPLICATIONS

This application is related to and claims priority from Japanese Patent Application No. 2005-174987 filed on Jun. 15, 2005, the contents of which are hereby incorporated by reference.

### BACKGROUND OF THE INVENTION

1. Field of the Invention

The present invention relates to a fuel cell, so-called a solid polymer proton-conducting cation-exchange electrolyte membrane fuel cell (PEFC), a fuel cell stack composed of a plurality of the fuel cells stacked in series, in which the fuel cell consists of a polymer proton exchange membrane sandwiched between two electrodes, anode and cathode, and further relates to a fuel cell system equipped with the fuel cell stack that is suitably applicable to movable bodies, such as electric vehicles (or fuel cell vehicles) using a fuel cell as an electric power source.

2. Description of the Related Art

FIG. 5 is a schematic sectional diagram showing a configuration of a part of a fuel cell 510 in a conventional polymer electrolyte fuel cell (PEFC). As shown in FIG. 5, the fuel cell 510 comprises a polymer proton exchange membrane 1, a cathode 504, an anode 505, and a pair of separators 507a and 507b. The polymer proton exchange membrane 501 is sandwiched between two electrodes, the cathode 504 and the anode 505, in order to form a lamination body 506.

The lamination body 506 is further sandwiched between a pair of the separators 507a and 507b in order to form the fuel cell 510 of a thin-plate shape.

FIG. 6A is a plan view showing an inside configuration of the separator 507b as one of the separators 507a and 507b in the fuel cell 510 shown in FIG. 5. FIG. 6B is a schematic sectional view of the fuel cell 510 along C-C line in FIG. 6A. In particular, FIG. 6B shows an exploded configuration of the fuel cell 510 in which the lamination body 506 and a pair of the separators 507a and 507b are separated to each other for easy understanding. In a concrete configuration, those components 506, 507a and 507b are sandwiched. FIG. 6A shows the configuration of the separator 507a in the fuel cell 510 along D-D line in FIG. 6B. Each element is designated by hatching in the figures, for example FIG. 6A, FIG. 6B, and FIG. 7.

The inner surface of each of the separator 507a and 507b has plural grooves 507c as fuel gas passages through which fuel gas such as hydrogen and air involving oxygen flow. Openings 508a to 508e formed at periphery of the separator 507b become holes that form gas manifolds 540 and 541 and a cooling water manifold 542 (see FIG. 7) when a plurality of the fuel cells 510 are stacked. Through the gas manifolds 540 and 541, gas is supplied to and drained from each gas passage in the fuel cell 510.

A plurality of the fuel cells 510 of a thin-plate shape are laminated or stacked in series in order to form a conventional fuel cell as shown in FIG. 7.

The fuel cell stack consisting of the plural fuel cells 510 laminated is sandwiched and pressed between pressure plates 522 by a screw 523 in the lamination direction.

As shown in FIG. 7, each fuel cell 510 has the gas manifolds 540, 541, and the cooling-water manifold 542. The main surface of each fuel cell 510 is placed in a direction perpendicular to the lamination direction of the fuel cells 10 forming the fuel cell stack. That is, on using the fuel cell stack, the main surface of each fuel cell 510 is placed along the direction perpendicular to the lamination direction of the fuel cell stack (see the top-bottom direction shown in FIG. 7).

A fuel cell system equipped with such a fuel cell stack comprises a hydrogen gas supply section 550, an air supply section 560, a hydrogen gas exhaust section 551, an air exhaust section 561, a cooling-water supply section 570 and a cooling-water drain section (not shown) that are joined to the fuel cell stack. Through the hydrogen gas supply section 550 hydrogen gas is supplied to the anode 505 of the fuel cell 510. Through the air supply section 560 air is supplied to the cathode 504 of the fuel cell 510. Through the hydrogen gas exhaust section 551, residual hydrogen gas that has not been reacted is exhausted to the outside of the fuel cell stack, Through the air exhaust section 561 air is exhausted to the outside of the fuel cell stack. In the fuel cell system having the above configuration, air is supplied to the cathode 504 and hydrogen gas is supplied to the anode 505 of the fuel cell stack. The fuel cell stack generates electric power by combining hydrogen and oxygen electrochemically and the electrical power generated is output through current collecting plate 531s to various kinds of electric devices.

During the electricity generation of the fuel cell stack, water is produced at the cathode 504 of the fuel cell stack according to the amount of current generated therein. In particular, water is produced by electrochemical reaction in the polymer proton exchange membrane 1 during the generation of the electric power.

Although water is one of important source for generating electric power because the amount of water affects proton conductivity in the polymer proton exchange membrane 1, excess water prevents the smooth gas supply into the fuel cell. Accordingly, it is preferred to drain excess water properly to the outside of the fuel cell stack.

During the generation of electric power, water is supplied through the cathode 504, and excess water and residual gas mainly involving nitrogen gas are drained to the outside of the fuel cell stack through the air exhaust section 561. Thus, the electrochemical reaction consumes oxygen involved in the air supplied to the cathode 504 in the fuel cell stack, and residual gas mainly involves nitrogen gas.

That is, the area in which the polymer proton exchange membrane 1 is sandwiched between the electrodes, the diffusion layer 503 and the catalyst layer 502 (see FIG. 5) in the fuel cell 510 is the electric generation area where electrochemical reaction occurs. However, after the stop of the electricity generation, water remains at the electric generation area.

When an ambient temperature of the fuel cell system drops below about 0° C. after the stoppage of the electricity generation, water remained in the diffusion layer 503 freezes. As shown in FIG. 5, the diffusion layer 503 in each of the cathode 504 and the anode 505 consists of carbon fibers having plural fine opening-voids through which gas and water are diffused in the diffusion layer 503. If the residual water freezes in the diffusion later 503 of the fuel cell 510, gas such as hydrogen and air could not be supplied and diffused therein, so that the fuel cell stack having the plural fuel cells 510 stacked cannot perform the electricity generation, namely the electricity generation stops.

In order to avoid this, when the ambient temperature of the fuel cell system equipped with the fuel cell stack drops below about 0° C., the conventional technique performs the electricity generation in order to rise the temperature of the fuel cell stack itself and to evaporate residual water in the diffusion layer of the fuel cell stack. A Japanese laid open publication number JP2004-311277 has disclosed such a conventional technique.

However, it is undesirable to heat the fuel cell stack by the electricity generation using hydrogen gas because a driver usually leaves a vehicle equipped with the fuel cell system. Such a manner of the conventional technique described above is further undesirable in view of electrical energy saving because of the use of hydrogen for heating the fuel cell stack.

### SUMMARY OF THE INVENTION

The present invention has been invented in view of a stacked configuration of fuel cells in a fuel cell stack, whose main surface of each fuel cell is placed vertically, namely, in a direction perpendicular toward the stacked direction of the fuel cells forming the fuel cell stack.

It is an object of the present invention to provide a fuel cell, a fuel cell stack made of plural fuel cells, and a fuel cell system equipped with the fuel cell stack, capable of draining or exhausting residual water produced in electricity generation area in a solid polymer proton-conducting cation-exchange electrolyte membrane fuel cell (PEFC) without any heating the fuel cell stack by using hydrogen after the stoppage of the electricity generation.

To achieve the above purposes, the present invention provides a fuel cell, a fuel cell stack, and a fuel cell system equipped with the fuel cell stack generating electrical power by electrochemical reaction of hydrogen and oxygen. In the fuel cell stack, those plural fuel cells are stacked in series along a direction perpendicular to a main surface of each fuel cell. Each fuel cell has an anode, a cathode, an electrolyte membrane sandwiched between the anode and the cathode. The anode, the cathode, and the electrolyte membrane form a lamination body. The lamination body is sandwiched by a pair of separators. In each fuel cell, a water collecting groove, configured to collect water produced by the electrochemical reaction, is formed in a bottom area of an inner surface of the separator, and the bottom of the water collecting groove is lower in position than a bottom end of each of the electrolyte membrane, the anode, and the cathode.

Because the main surface of each fuel cell arranged in the fuel cell stack is placed in a direction perpendicular to the lamination direction of the stacked fuel cells, the electrolyte membrane, the anode, and the cathode are placed vertically, namely, in the direction perpendicular to the lamination direction of the stacked fuel cells. Further, the water collecting groove is formed at a lower area than the bottom of the electricity generation area made of the electrolyte membrane, the anode and the cathode.

The residual water in each fuel cell drops from the electricity generation area to the water collecting groove by the gravity. The water collecting groove accumulates the residual water and drain the accumulated one to the outside of the fuel cell stack.

Therefore the configuration of the fuel cell and the fuel cell stack according to the present invention is capable of exhausting the residual water efficiently by the gravity without heating the fuel cell stack after the stoppage of the electricity generation. That is, according to the present invention, it is possible to exhaust the residual water produced in the electricity generation area of each fuel cell in the polymer electrolyte fuel cell without using hydrogen.

### BRIEF DESCRIPTION OF THE DRAWINGS

A preferred, non-limiting embodiment of the present invention will be described by way of example with reference to the accompanying drawings, in which:

FIG. 1 is a schematic sectional view showing a configuration of a part of a fuel cell such as a PEFC that forms a fuel cell stack according to an embodiment of the present invention;

FIG. 2A is a schematic sectional view showing an inside configuration of a separator forming the fuel cell shown in FIG. 1;

FIG. 2B is a schematic sectional view showing a configuration of one separator forming the fuel cell along A-A line shown in FIG. 2A;

FIG. 3 is a sectional view of the fuel cell stack consisting of a plurality of fuel cells of PEFC stacked;

FIG. 4 is an entire schematic view showing another configuration of the fuel cell stack according to another embodiment of the present invention;

FIG. 5 is a schematic sectional diagram showing a configuration of a part of a conventional fuel cell in a conventional polymer electrolyte fuel cell;

FIG. 6A is a plan view showing an inside configuration of one separator in the conventional fuel cell shown in FIG. 5;

FIG. 6B is a schematic sectional view of the fuel cell along C-C line in FIG. 6A;

FIG. 7 is a sectional diagram showing a configuration of a conventional fuel cell stack in which plural fuel cells are laminated; and

FIG. 8 is a schematic sectional view showing another configuration of a part of the fuel cell forming the fuel cell stack according to the embodiment of the present invention;

### DETAILED DESCRIPTION OF THE PREFERRED EMBODIMENTS

Hereinafter, various embodiments of the present invention will be described with reference to the accompanying drawings. In the following description of the various embodiments, like reference characters or numerals designate like or equivalent component parts throughout the several diagrams.

### Embodiments

A description will now be given of the fuel cell and the fuel cell system according to various embodiments of the present invention.

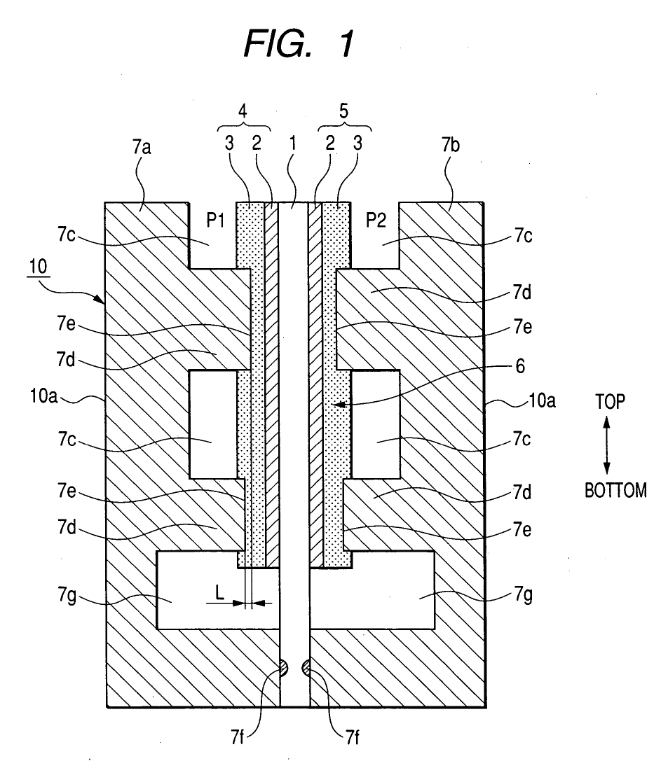

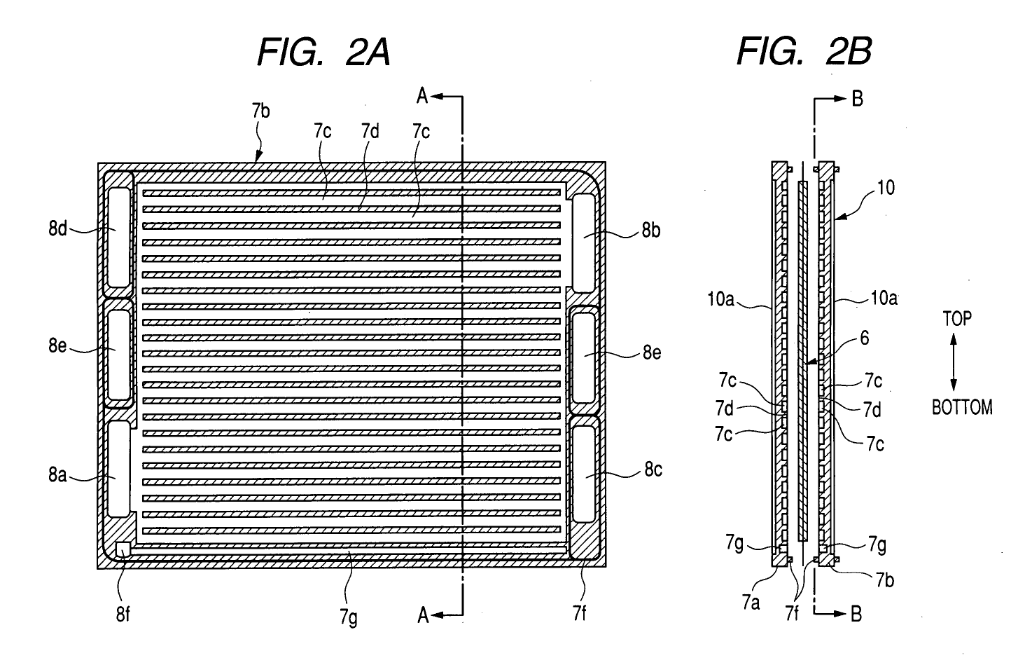

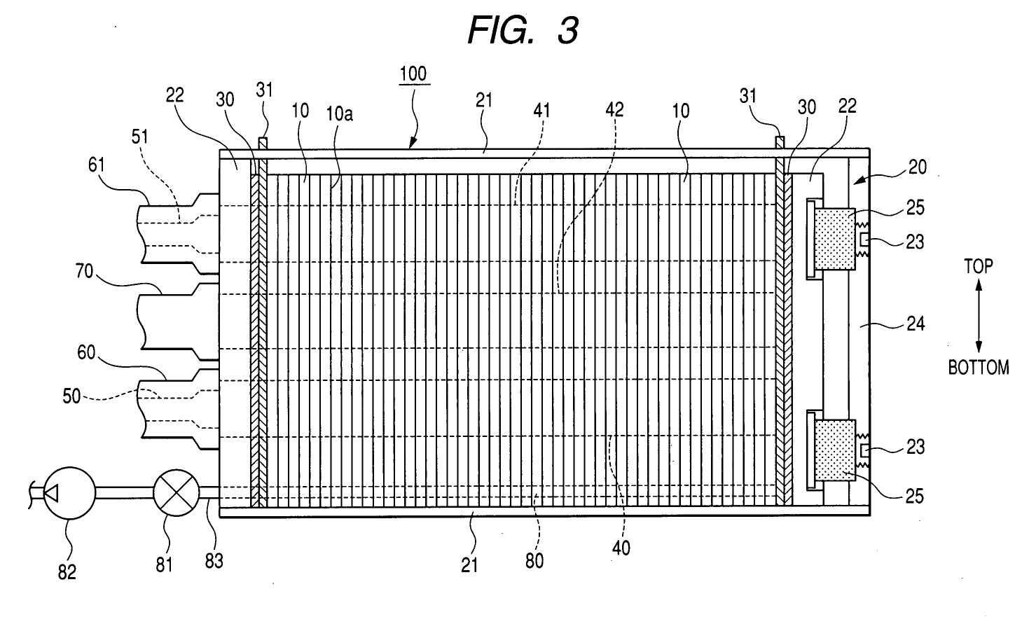

FIG. 1 is a schematic sectional view showing a configuration of a part of the fuel cell in a solid polymer proton-conducting cation-exchange electrolyte membrane fuel cell (PEFC) that forms the fuel cell stack 100 (see FIG. 3) according to an embodiment of the present invention. FIG. 2A is a schematic sectional view showing the inside configuration of one separator forming the fuel cell shown in FIG. 1. FIG. 2B is a schematic sectional view showing the configuration of the fuel cell along A-A line in FIG. 2A.

In particular, FIG. 2B shows an exploded configuration of the fuel cell 10 in which the lamination body 6 and a pair of separators 7a and 7b are separated to each other for easy understanding. In a concrete configuration, the lamination body 6 and the separators 7a and 7b are sandwiched. FIG. 2A shows the configuration of the separator 7a in the fuel cell 10 along B-B line in FIG. 2B. Each element is designated by hatching in the figures, for example FIG. 2A, FIG. 2B, and FIG. 3.

The cathode 4, the anode 5, and the solid polymer proton-conducting cation-exchange electrolyte membrane 1 are bonded to form a single multi-layer composite structure such as a membrane electrode assembly (MEA). The solid polymer proton-conducting cation-exchange electrolyte membrane 1 is sandwiched between two electrodes, the cathode 4 and the anode 5, in order to form a lamination body 6.

The lamination body 6 is further sandwiched between a pair of the separators 7a and 7b in order to form the fuel cell 10 of a thin-plate shape. In FIG. 1, FIG. 2A, and FIG. 2B, reference character 7a designates the separator of the anode 5, and reference character 7b denotes the separator of the cathode 4.

When hydrogen gas is supplied to the anode 5 and air involving oxygen gas is supplied to the cathode 4, the fuel cell 10 commences electricity generation by combining hydrogen gas and oxygen electrochemically, and the electric power generated is output through both electrodes 4 and 5 to the outside of the fuel cell 10.

Each fuel cell 10 generates electrical energy by an electrochemical reaction of hydrogen and oxygen.

Hydrogen electrode (Anode): H₂→>2H⁺+2e⁻, and

Oxygen electrode (Cathode): 2H⁺+1/2O₂+2e⁻→>H₂O.

In a concrete example, the polymer proton exchange membrane 1 can be made of a polymer electrolyte film having ion conductivity capability such as fluorine contained ion exchange resigns. In general, the polymer proton exchange membrane 1 is made of ion exchange resins and typically comprises a perfluoronated sulfonic acid film such as NAFION™ available from Dupont Co.

Each of the cathode 4 and the anode 5 in the fuel cell 10 is made of a catalyst layer 2 and an electric conductivity diffusion layer 3. Electrochemical reaction occurs at the catalyst layer 2. The electric conductivity diffusion layer 3 acts as electricity collecting body.

The polymer proton exchange membrane 1, the catalyst layer 2, and the diffusion layer 3 are laminated in order.

The catalyst layer 2 is made of a resign including platinum as catalyst or alloy made up of platinum and other metals. The catalyst layer 2 is formed on both the surfaces of the polymer proton exchange membrane 1 in a lamination structure.

The diffusion layer 3 is made of carbon fibers cloth or paper such as carbon fiber cloth or carbon fiber nonwoven cloth. The current generated in the fuel cell 10 is supplied to the outside of the fuel cell 10 through the diffusion layer 3. In general, the diffusion layer 3 has plural fine opening-voids therein, through which gas and water are diffused. If the diffusion layer 3 has a high degree of fine opening-voids, it is possible to easily supply gas through the fine opening-voids and to smoothly drain water to the outside of the fuel cell 10 because gas and water flow easily through the diffusion layer 3. It is desirable that most carbon fibers are oriented along the longitudinal direction of the fuel cell 10 (top-bottom direction shown in FIG. 1) when the diffusion layer 3 is made of carbon fibers cloth or carbon fiber nonwoven cloth.

Both the separators 7a and 7b are made of an electro-conductive plate, also called bipolar plate, manufactured by solidifying carbon granules with phenol resin or by metal plate and cutting or molding it in a desired shape.

Grooves 7c are formed in the inner surface of the separators 7a and 7b. The grooves 7c act as fuel gas passage 7c through which fuel gases such as hydrogen gas and air flow.

In the fuel cell 10 of the fuel cell stack 100 according to the present invention, hydrogen gas flows through the fuel gas passage 7c of the separator 7a of the anode 5, and air flows through the fuel gas passage 7c of the separator 7b of the cathode 4.

Land areas 7d are formed between the adjacent fuel gas passages 7c in the separators 7a and 7c, and act as partition wall of the adjacent fuel gas passages 7c.

The surface 7e of the land area 7d is contacted to the diffusion layer 3. Through the surface 7e, the land area 7d is electrically connected to the diffusion layer 3. The fuel gas passage 7c is a groove and therefore does not electrically connect to the diffusion layer 3. Through the fuel gas passage 7c, fuel gas is supplied to the diffusion layer 3.

In order to electrically connect the land areas 7d of the separators 7a and 7b with the diffusion layer 3 certainly, a pressure is applied from the outside of the fuel cell 10 to the outer surfaces of both the separators 7a and 7b. The magnitude of the applied pressure is approximately 500 kPa.

Because the part of the diffusion layer 3 contacted to the land areas 7d is pressed, there is very little to leak the fuel gas between the adjacent fuel gas passages 7c through the land area 7d.

FIG. 2A and FIG. 2B show the entire configuration of the inner surfaces of the separators 7a and 7b in detail. Although FIG. 2A shows only the inner surface of the separator 7a of the anode 5, the inner surface of the separator 7b of the cathode 4 has the same configuration.

As shown in FIG. 2A and FIG. 2B, a plurality of the fuel gas passages 7c are formed in parallel to each other and the land areas 7d are formed as partition wall between the fuel gas passages 7c.

On manufacturing the fuel cell stack 100 by stacking the plural fuel cells 10, the opening areas 8a, 8b, 8c, 8d, and 8e formed near the periphery of the separator 7b are used to form the gas manifolds 40 and 41 (see FIG. 3) and the cooling water manifold 42 (see FIG. 3). The fuel gases are supplied to the fuel gas passages 7c through the gas manifolds 40 and 41, and the cooling water are supplied to and drained from the cooling water manifold 42.

For instance, as shown in FIG. 2A, the opening placed at the bottom left area is the hydrogen supply inlet 8a through which hydrogen gas as fuel gas is supplied to the anode 5, and the opening placed at the upper right area is the hydrogen exhaust outlet 8b through which non-reacted residual hydrogen gas is exhausted from the fuel cell 10.

Both the hydrogen supply inlet 8a and the hydrogen exhaust outlet 8b are joined to the fuel gas passages 7c of the separator 7a of the anode 5. Hydrogen gas from the hydrogen supply inlet 8a flows through the fuel gas passages 7c, and drained from the hydrogen exhaust outlet 8b to the outside of the fuel cell 10 after the electrochemical reaction.

Further, the opening placed at the bottom right area is the air supply inlet 8c through which air as fuel gas is supplied to the cathode 4, and the opening placed at the upper left area is the air exhaust outlet 8d through which residual air that has not been reacted is exhausted to the outside of the fuel cell 10.

Both the air supply inlet 8c and the air exhaust outlet 8d are joined to the fuel gas passages 7c formed on the separator 7b of the cathode 4 (those connections are omitted from drawings), air flows from the air supply inlet 8c to the air exhaust outlet 8d through the fuel gas passages 7c of the separator 7b of the cathode 4 after the electrochemical reaction.

As shown in FIG. 2A, the openings 8e placed at the middle left area and the middle right area are openings through which the cooling water flows to cooling water passages (not shown) formed at the outside of the separators 7a and 7b. One of the openings 8e acts as the cooling water inlet and the other acts as the cooling water outlet.

Adhesion sealing sections 7f designated by bold slant lines are formed at the inner surfaces of the separators 7a and 7b in order to keep the sealing of the fuel cell 10 when the lamination body 6 is sandwiched by both the separators 7a and 7b.

The configuration of the lamination body 6 sandwiched by a pair of the separators 7a and 7b can prevent to leak and diffuse the fuel gases to the outside of the fuel cell and can provide to external devices (not shown) the electric power generated by electrochemical reaction with hydrogen gas and oxygen gas in the fuel cell stack 100 (see FIG. 3).

FIG. 3 is a sectional view of the fuel cell stack 100 that consists of a plurality of the fuel cells 10 of a thin plate shape. The fuel cells 10 are stacked in series. As shown in FIG. 3, the pressure fastening means 20 presses and fastens in the stacked direction the plural fuel cells 10 forming the fuel cell stack 100.

The pressure fastening means 20 of the embodiment according to the present invention comprises a frame 21, a pair of pressure plates 22, screws 23, a plate 24, and piezo actuators 25. The frames 21 support a pair of the pressure plates 22. One of the pressure plates 22 is pressed by the fastening of the screws 23. The plate 24 is fixed to the frame 21 and fastened by the screws 23. The piezo actuators 25 are placed between the pressure plate 22 and the screw 23.

As shown in FIG. 3, the fuel cells 10 stacked are sandwiched by both the pressure plates 22 and fastened by the screws 23.

Electricity collecting plates 31 are placed between the pressure plates 22 through insulating plates 30.

Through the electricity collecting plates 31, the current output from the fuel cell stack 100 consisting of the plural fuel cells 10 stacked is provided to the outside of the fuel cell stack 100. For example, the electricity collecting plate 31 is made of gold-plated brass plate. The insulating plate 30 is made of glass epoxy resin, and is capable of insulating the electricity collecting plates 31 from the pressure plates 22.

Each piezo actuator 25 in the pressure fastening means 20 is made of a piezoelectric element such as PZT, and becomes long in length according to increasing the magnitude of the applied pressure.

The piezo actuators 25 are connected electrically to the electricity collecting plates 31 through wirings (not shown). Through the wirings the output voltage from the fuel cell stack 100 is applied to the piezo actuators 25. Because the voltage is applied to the piezo actuators 25 during the electrical power generation of the fuel cell stack 100, the length of each piezo actuator 25 increases and the piezo actuator 25 presses the pressure plate 22 in addition to the fastening force by the screws 23. On the contrary, during the stoppage of the electricity generation, because the length of the piezo actuator 25 decreases, the magnitude of the pressure to the pressure plated 22 becomes decreased.

As described above, the pressure fastening means 20 of the embodiment has the function to fasten the plural fuel cells 10 toward its stacked direction by the variable-pressure applying function.

In the embodiment, the entire of the fuel cells 10 stacked is sandwiched between the pressure plates 22, the piezo actuators 25 are further placed between one of the pressure plates 22 and the frame 24, and the fuel cells 10 are fastened from the frame 24 end by the screws 23 in the pressure fastening means 20.

Further, as described above, the gas manifolds 40 and 41 and the cooling water manifold 42 are formed in the fuel cell stack 100 made up of the stacked fuel cells 10 as shown in FIG. 3. That is, FIG. 3 shows the hydrogen gas supply manifold 40 made of the hydrogen gas supply inlets 8a connected together shown in FIG. 2A, the air exhaust manifold 41 made of the air exhaust outlets 8d connected together, and the cooling water manifold 42 made of the cooling water openings 8e connected together.

The fuel cell stack 100 has the hydrogen gas exhaust manifold made of the hydrogen gas exhaust outlets 8b connected together and the air supply manifold made of the air supply inlets 8c connected together. However, FIG. 3 omits those manifolds for brevity.

Although the embodiment of the present invention provides the fuel cell system equipped with the fuel cell stack 100, FIG. 3 shows some elements of the fuel cell system for brevity.

That is, the fuel cell system of the present embodiment has the hydrogen supply section 50 for supplying hydrogen gas to the anode 5, the air supply section 60 for supplying air to the cathode 4, the hydrogen gas exhaust section 51 through which non-reacted residual hydrogen gas is exhausted from the anode 5, the air exhaust section 61 through which air is exhausted from the cathode 4, and the cooling water supply section 70, and the cooling water exhaust section (omitted from FIG. 3). Those sections 50, 51, 60, 61, 70, and the cooling water exhaust section are mounted on the fuel cell stack 100 and joined to those manifolds through pipes. For instance, the hydrogen supply section 50 is joined to the hydrogen gas supply manifold 40 through the pipe, the hydrogen gas exhaust section 51 is joined to the hydrogen gas exhaust manifold through the pipe, the air supply section 60 is joined to the air supply manifold through the pipe, the air exhaust section 61 is joined to the air exhaust manifold 41 through the pipe, and the cooling water supply section 70 and the cooling water exhaust section are joined to the cooling water manifolds through the pipes, respectively.

Through those supply sections, hydrogen gas and air and cooling water are supplied to the fuel cell stack 100 through those manifolds and exhausted through those exhaust sections during the electrical power generation.

Pumps and valves (not shown) are mounted on those supply sections and exhaust sections, and are controlled by a control circuit (not shown) such as an electric control unit (ECU) mounted on a vehicle, just like usual fuel cell systems.

In the fuel cell system of the embodiment according to the present invention, air is supplied to the cathode 4 and hydrogen is supplied to the anode 5 in the fuel cell stack 100, and the electrochemical reaction of oxygen in the air and hydrogen are performed based on the prescribed chemical equations in order to generate electric power.

The output current from the fuel cell stack 100 is provided through the electricity collecting plates 31 to various electric devices. Such a fuel cell system is suitably applicable to movable bodies, such as electric vehicles (or fuel cell vehicles) using a fuel cell as an electric power source. Further, the electrical power generated by the fuel cell stack 100 is supplied to various electric devices such as motors and further is charged to a secondary battery.

The fuel cell stack 100 of the embodiment is mounted on a vehicle so that the main surface 10a of each fuel cell 10, that is vertical to the stacked direction of the fuel cells 10, is aligned in the direction designated by the reference characters “top <--->bottom” shown in FIG. 3.

One of the important features of the fuel cell stack 100 of the embodiment according to the present invention is as follows:

Each fuel cell 10 has the grooves 7g formed at the bottom part of the inner surface of each of the separators 7a and 7b that are lower in position than the bottom end of each of the catalyst layer 2, the diffusion layer 3, and the polymer proton exchange membrane 1 as shown in FIG. 1, FIG. 2A, and FIG. 2B. Hereinafter, the groove 7g will be called to as water collecting groove.

The water collecting groove 7g is not joined to the fuel gas supply passage 7c formed in each of the separators 7a and 7b. That is, the water collecting groove 7g is not joined to the fuel gas supply sections in the fuel cell system.

In the configuration of the fuel cell 10 shown in FIG. 1, the bottom end of each of the catalyst layer 2 and the diffusion layer 3 slightly protrudes into the water collecting groove 7g. The present invention is not limited by this configuration. It is acceptable that the bottom end of each of the catalyst layer 2 and the diffusion layer 3 protrudes into the intermediate position or more of the water collecting groove 7g unless the bottom end of each of the catalyst layer 2 and the diffusion layer 3 is contacted to the bottom of the water collecting groove 7g. In other words, it is necessary to have a space between the bottom surface of the water collecting groove 7g and the bottom end of each of the catalyst layer 2 and the diffusion layer 3. The bottom surface of the water collecting groove 7g is lower in position than the bottom end of each of the catalyst layer 2 and the diffusion layer 3, as clearly shown in FIG. 1.

Further, as shown in FIG. 2A, the water collecting groove 7g is formed in parallel to the fuel gas passage 7c. An opening section 8f is formed in a part of the water collecting groove 7g. The opening section 8f (see FIG. 2A) forms the water exhaust manifold 80 (see FIG. 3) in the fuel cell stack 100 in which the fuel cells are stacked.

As shown in FIG. 3, the water exhaust manifold 80 is formed by sequentially connecting the opening sections 8f of the plural fuel cells 10. Through the water exhaust manifold 80, water accumulated in the water collecting grooves 7g in the fuel cells 10 can be drained to the outside of the fuel cell system.

Further, in the fuel cell system of the embodiment shown in FIG. 3, the water exhaust manifold 80 in the fuel cell stack 100 is joined to the exhaust section 83 having the water exhaust valve 81 and the water exhaust pump 82. The operation of those exhaust valve 81 and the exhaust pump 82 is controlled by the control circuit such as the ECU to be mounted on a vehicle.

As described above, according to the embodiment of the present invention, the fuel cell stack 100 comprises a plurality of the fuel cells 10 stacked in series along a direction vertical to a main surface of each fuel cell 10. Each fuel cell 10 comprises the anode 5, the cathode 4, the polymer proton exchange membrane 1 sandwiched between the anode 5 and the cathode 4 that form a lamination body. The electrolyte membrane 1 is made of a polymer proton exchange membrane. Each of the anode 5 and the cathode 4 comprises the diffusion layer 3 and the catalyst layer 2 contacted to the polymer proton exchange membrane 1. The lamination body is sandwiched between a pair of the separators 7a and 7b.

In the configuration of the fuel cell stack in which each fuel cell 10 is placed or stacked along the stacked direction vertical to the main surface of each fuel cell 10. The water collecting grooves 7g, configured to collect water generated by electrochemical reaction in each fuel cell 10, is formed in a bottom area of the inner surface of each of the separators 7a and 7b in the fuel cell. The bottom of the water collecting groove 7g is lower in position than a bottom end of each of the electrolyte membrane 1, the anode 5, and the cathode 4. The water collecting grooves 7g are not joined to the fuel gas passages 7c. The fuel gas passages 7c are formed in the inner surface of the separators 7a and 7b and above the water collecting grooves 7g. Through the fuel gas passages 7c, fuel gasses such as hydrogen and air flow and are provided to the diffusion layer 3, the catalyst layer 2, and the polymer proton exchange membrane 1.

Based of the above configuration of the fuel cell stack 100, because the main surface 10a of each fuel cell 10 is placed vertically to the stacked direction of the plural fuel cells 10, the polymer proton exchange membrane 1, the catalyst layer 2, and the diffusion layer 3 forming the generation area of the electricity in each fuel cell 10 are placed vertically to the stacked direction of the fuel cells 10.

During the generation of the electrical power in the fuel cell stack 100, water is produced in the cathode 4 according to the amount of current generated in the fuel cell stack 100. The water produced is drained together with residual air that has not been reacted to the outside of the fuel cell stack 100 during the generation of the electrical power, but remained in the fuel cell 10 after the stoppage of the electricity generation.

For example, if the fuel cell 10 has an electricity generation area of approximately 400 cm², the accumulated amount of water becomes approximately 10 cc or more that are accumulated mainly in the cathode 4 of the fuel cell 10 and a part of which is remained in the polymer proton exchange membrane 1 and the diffusion layer 3.

When the ambient temperature of the fuel cell stack 100 is 0° C. or below after the stoppage of the electricity generation, the residual water in the diffusion layer 3 freezes. The frozen water prevents the supply of the fuel gases such as hydrogen and air, and stops the electricity generation in the fuel cell stack 100. In order to avoid this, it is necessary to drain the residual water in the diffusion layer 3 in the electricity generation area to the outside of the fuel cell 10.

After the stoppage of the electricity generation, the water in the cathode 4 permeates the anode 5. Further, because the diffusion layer 3 is elongated along the top and bottom direction (or vertical direction) shown in FIG. 1, the water in the diffusion layer 3 permeates and drops toward the bottom area of the diffusion layer 4 by the gravity. After a long time elapsed, approximately two hours later, for example, the water is accumulated at the bottom area of the diffusion layer 3. In the fuel cell 10 of the embodiment, the water collecting groove 7g is formed at the bottom part of each of the separator 7a and 7b that is lower in position than the bottom end of the electricity generation area (made of the cathode 4, the anode 5, and the polymer proton exchange membrane 1) of each fuel cell 10 in order to collect the water by the gravity. Thus, the residual water in electricity generation area such as the diffusion layer 3 is collected and then drained.

As described above, the fuel cell 10 and the fuel cell stack 100 can remove the residual water by the gravity after the stoppage of the electricity generation in the fuel cell stack 100. The above feature of the fuel cell 10 and the fuel cell stack 100 can avoid the electrical power consumption to remove the residual water. In other words, the fuel cell stack 100 of the embodiment can remove the residual water in the electricity generation area of the fuel cell 10 by the gravity without consuming any electrical energy.

Further, one of the features of the fuel cell system of the embodiment is to have the water exhaust manifold 80, as shown in FIG. 3, in the fuel cell stack 100. Because the residual water accumulated in the water collecting grooves 7g flows into the water exhaust manifold 80 in the order of arrival, it is easily possible to drain the residual water accumulated in the water collecting grooves 7g through the water exhaust manifold 80 efficiency.

The residual water accumulated in the water collecting grooves 7g are then exhausted through the exhaust section 83 (see FIG. 3).

The exhausted water from the water exhaust manifold 80 is drained through the exhaust section 83. In the embodiment, the wide and the depth of the water collecting groove 7g are 2 mm and 1.5 mm, respectively. When the length of the water collecting groove 7g is 20 cm long, the volume of the groove 7g becomes 0.6 cc. In this configuration of the water collecting groove 7g, because the total volume of both the cathode 4 and the anode 5 becomes 1.2 cc at the most, it is preferred to drain the residual water in the electricity generation area to the water collecting grooves 7g.

However, the present invention is not limited by the above configuration of the fuel cell 10 and the fuel cell stack 100, it is acceptable to mount a water tank (not shown) at the outside of the fuel cell stack 100 to which the residual water is accumulated without draining the residual water to the outside of the fuel cell stack 100 through the exhaust section 83. In this case, the water accumulated in the water tank is drained to the outside of the fuel cell system after the water tank (not shown) fills with the residual water.

Although it is preferred to commence the drain of the residual water accumulated in the water collecting groove 7g through the water exhaust manifold 80 as soon as the accumulation of the water in the groove 7g, it is also possible to commence the drain of the water accumulated in the groove 7g after ten minutes later counted from the stoppage of the electricity generation, or after a temperature sensor detects that the temperature of the fuel cell stack 100 becomes lower than a prescribed temperature value after the stoppage of the electricity generation.

In order to avoid any problem caused by frozen, it is preferred to commence the drain of the residual water accumulated in the water collecting groove 7g before the temperature of the fuel cell stack 100 becomes 0° C. or less.

Further, it is preferred to form the residual water collecting groove 7g in the inner surface of the separator 7a faced to the cathode 4 in the fuel cell 10 of the fuel cell stack 100 of the embodiment.

In the configuration of the fuel cell stack 100 of the embodiment, the water is produced in the cathode side as oxygen electrode during the electrochemical reaction in the electricity generation, as prescribed by the chemical reaction equations. Accordingly, after the stoppage of the electricity generation of the fuel cell stack 100, the residual water more remains in the diffusion layer 3 of the cathode 4 rather than the diffusion layer 3 of the anode 5.

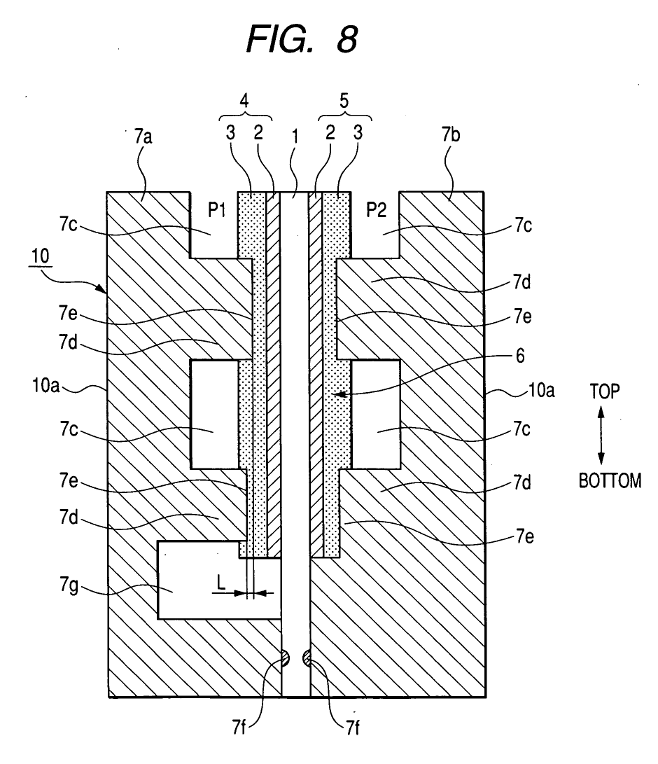

The configuration of the embodiment shown in FIG. 1 to FIG. 4 shows the water collecting grooves 7g that are formed in the inner surface of the separators 7a and 7b of both the anode 4 and the cathode 5. Because the residual water more remains in the diffusion layer 3 of the cathode 4 rather than that of the anode 5, it is also acceptable to form the water collecting groove 7g only in the surface of the separator 7a of the cathode 4. FIG. 8 shows the configuration of the water collecting groove 7g that is formed in the inner surface of the separator 7a of the anode 4. This configuration only having the water collecting groove 7a in the inner surface of the separator 7a can also exhaust the residual water collected effectively.

Still further, in both the separators 7a and 7b of the present embodiment having the configuration shown in FIG. 1, the surface 7e of a land area 7d, faced to the diffusion layer 3, formed between the water collecting groove 7g and the adjacent fuel gas passage 7c is more separated from the surface of the polymer proton exchange membrane 1 by the distance L (see FIG. 1) than the case of the surface 7e of the land area 7d formed between the adjacent fuel gas passages 7c.

In other words, as shown in FIG. 1, the surface 7e of the land area 7d, faced to the diffusion layer 3, formed between the water collecting groove 7g and the adjacent fuel gas passage 7c thereof is more apart from the surface of the polymer proton exchange membrane 1 by the distance L (see FIG. 1) than the case of the surface 7e of the land area 7d, faced to the diffusion layer 3, formed between the adjacent fuel gas passages 7c.

According to the configuration, the surface pressure to be applied from the land area 7d to the bottom area of the diffusion layer 3 between the water collecting groove 7g and the adjacent fuel gas passage 7c can be decreased than the surface pressure to be applied from the land area 7d to the diffusion layer 3 other than the above bottom area, between the adjacent fuel gas passages 7c.

It is thereby easily possible that the residual water drops or falls smoothly into the water collecting groove 7g by the gravity through the bottom end of the diffusion layer 3, faced to the land area 7d formed between the water collecting groove 7g and the adjacent fuel gas passage 7c.

Still further, according to the embodiment as described above, when the diffusion layer 3 is made of a carbon fiber cloth or a carbon fiber nonwoven cloth, it is preferred to orient or alien the carbon fibers approximately along the top and bottom direction shown in FIG. 1. This means that the most carbon fibers forming the diffusion layer 3 is oriented toward the direction to the water collecting groove 7g on average.

The carbon fibers in the carbon fiber cloth or a carbon fiber nonwoven cloth forming the diffusion layer 3 are oriented along the top and bottom direction shown in FIG. 1, and plural microscope water passages formed in the diffusion layer 3 are oriented toward the water collecting groove 7g. The residual water in the diffusion layer 3 can easily move toward the bottom direction, namely toward the water collecting groove 7g, as a result, this configuration of the carbon fibers forming the diffusion layer 3 promotes the drop of the residual water to the water collecting groove 7g by the gravity.

In addition, according to the embodiment, as shown in FIG. 3, the magnitude of pressure force of the pressure fastening means 20 pressing and fastenings in the stacked direction the plural fuel cells 10 forming the fuel cell stack 100 can be changed. This is one of the featured of the embodiment.

Still further, as shown in FIG. 1, because both the separators 7a and 7b in each fuel cell 10 are pressed by the pressure fastening means 20, it is difficult to flow the residual water to the water collecting groove 7g through a part of the diffusion layer 3 near the land area 7d pressed by the surface pressure applied from the land area 7d.

In order to eliminate the above problem, because the pressure fastening means 20 in the fuel cell system of the embodiment is capable of changing its pressure force to be applied to the fuel cell stack 100, in order to promote the collecting of the residual water through the diffusion layer 3 by the gravity, the pressure fastening means releases its pressure force in order to enlarge the microscopically small openings of the diffusion layer 3.

For instance, if the electricity generation area of each fuel cell 10 in the fuel cell stack 100 has approximately 400 cm² and the pressure fastening means 20 presses the fuel cell stack 100 by approximately 20 kN, the surface pressure of the land area 7d becomes 500 kPa. If this surface pressure is reduced to 80 percentages thereof, the pressure force to the diffusion layer 3 is reduced, and the movement of the residual water from the diffusion layer 3 to the water collecting groove 7g can be promoted.

For example, when the fuel cell stack 100 is formed with two-hundred fuel cells 10, the surface pressure of the pressure fastening means 20 is released by approximately 20 mm in stroke, the pressed length of each fuel cell 10 is released by approximately 0.05 mm. Because the energy necessary to reduce the surface pressure to the fuel cells 10 is therefore small, various types of actuators can be used for the pressure fastening means 20.

In a concrete example, the fuel cell system of the present embodiment has the piezo actuator 25 whose length becomes long when a voltage is applied, and returned to the original length when no voltage is applied.

As described above, the output voltage of the fuel cell stack 100 is applied to the piezo actuator 25 in the embodiment.

During the electricity generation of the fuel cell stack 100, the length of the piezo actuator 25 becomes long, so that it presses strongly to the stacked fuel cells 10. After the stoppage of the electricity generation, the length of the piezo actuator 25 is returned to the original one, and the pressure force to the fuel cells 10 becomes small. This configuration of the embodiment does not require any control signal to be supplied to the piezo actuator 25. In addition, because the voltage is generated in a moment when the electricity generation commences again, the fuel cell stack 100 is returned to its original length.

By using the piezo actuator 25 having the capability described above, it is possible to collect the residual water to the water collecting grooves 7g efficiently by releasing the magnitude of the surface pressure, without any monitoring the commencement and stoppage of the electricity generation of the fuel cell stack 100 by checking the magnitude of the output voltage from the fuel cell stack 100, and without consuming the electricity power after the stoppage of the electricity generation.

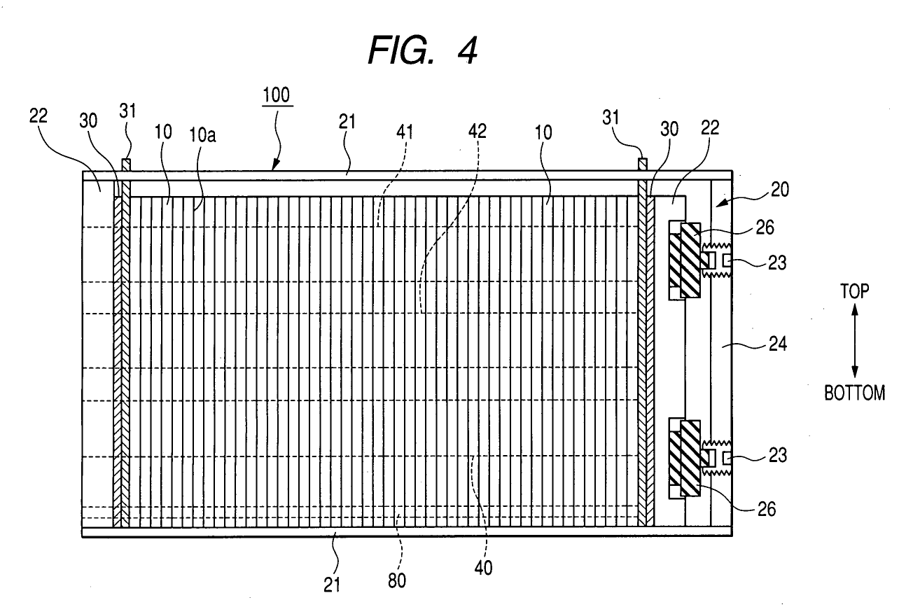

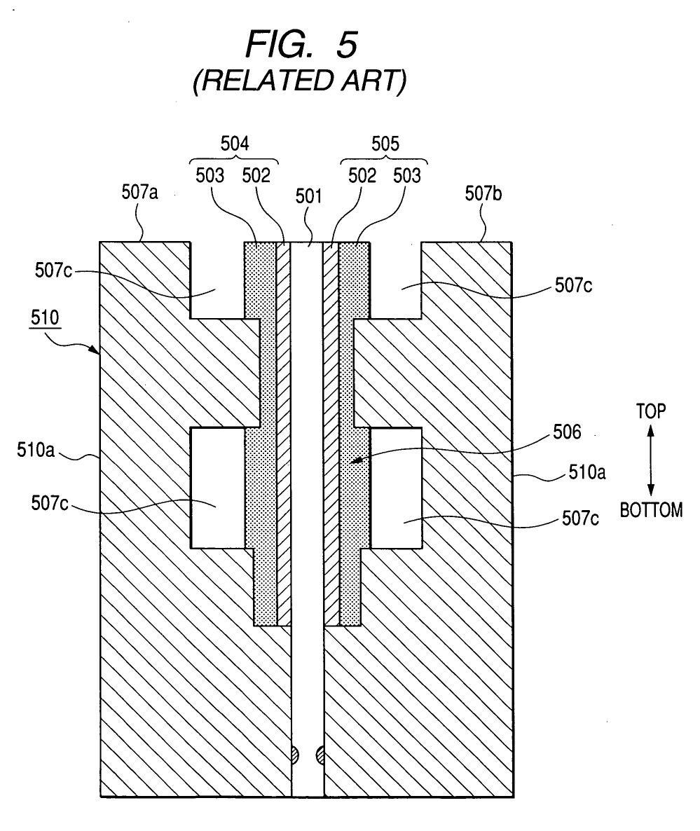

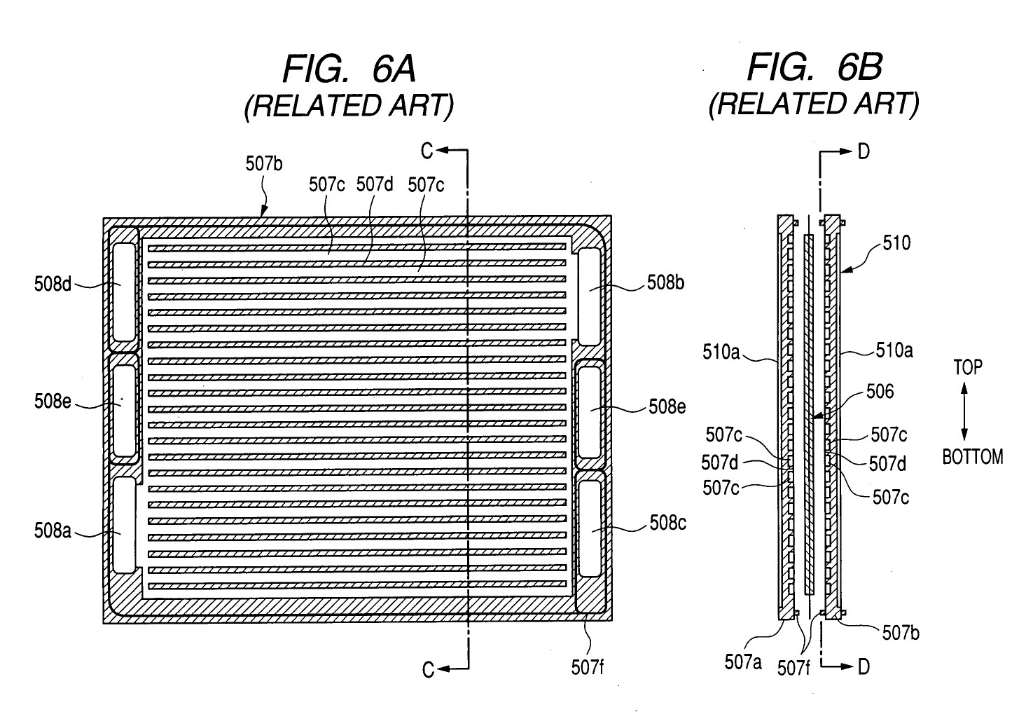

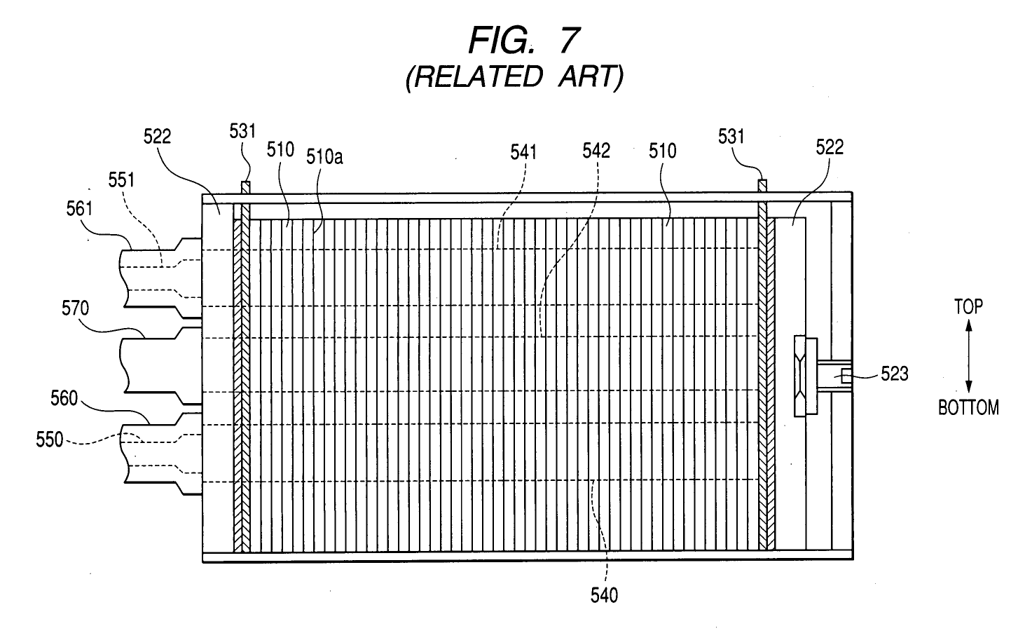

FIG. 4 is an entire schematic view showing another configuration of the fuel cell stack 100 according to another embodiment of the present invention.

In the configuration shown in FIG. 4, an actuator 26 is used instead of the piezo actuator 25. This actuator 26 is capable of changing its volume according to the ambient temperature, in particular, its volume is reduced according to the reduction of the ambient temperature. It is possible to use a solid element and a liquid whose volume is largely changed according to the change of the ambient temperature.

In the embodiment, a thermo-wax is used as the actuator instead of the piezo actuator whose volume is expanded at a high temperature and reduced at a lower temperature. In general, the temperature of the fuel cell stack 100 is increased during the electricity generation and decreased after the stoppage of the electricity generation. Because the volume of the thermo-wax 26 is reduced after the stoppage of the electricity generation, it is possible to release the magnitude of the surface pressure generated by the thermo-wax 26 to the fuel cells 10.

In the present embodiment, that is, because the fuel cell stack 100 becomes relatively a high temperature during the electricity generation, the thermo-wax 26 expanding by the thermal energy presses and fastens strongly the stacked fuel cells 10. After the stoppage of the electricity generation, because the fuel cell stack 100 becomes a low temperature (approximately 10° C.), the thermal-wax 26 is condensed and releases the pressure to the stacked fuel cells 10 and it is thereby promoted to drop residual water to the water collecting grooves 7g through the diffusion layer 3 in the fuel cell 10.

By using the thermal-wax 26 as the pressure fastening means, it is possible to exhaust the residual water to the outside of the fuel cells 10 through the water collecting grooves 7g efficiently by releasing the surface pressure to be applied to the fuel cell stack 100 by the thermo-wax 26 without any monitoring the temperature of the fuel cell stack 100 to detect its operating state such as working and stoppage of the fuel cell stack 100 and without consuming unnecessary electrical energy for removing the residual water in the fuel cell 10 after the stoppage of operation of the fuel cell stack 100.

In addition, the present embodiment further provides the fuel cell system having the fuel cell stack 100, the hydrogen supply section 50 configured to supply hydrogen to the anode 5, the air supply section 60 configured to supply air to the cathode 4, as shown in FIG. 3. In the fuel cell system, the electricity generation is performed by performing electrochemical reaction of the hydrogen and oxygen involved in the air.

Thus, the present invention can provide the fuel cell system equipped with the fuel cell stack 100 comprising the plural fuel cells 10 capable of performing the features described above.

Furthermore, it is acceptable to move the residual water from a high pressure end to a low pressure end in the fuel cell 10 by a pressure difference between the gases to be supplied to the anode 5 and the cathode 4, respectively, after the stoppage of the electricity generation of the fuel cell stack 100.

In the fuel cell system equipped with the fuel cell stack 100 shown in FIG. 3 and FIG. 4, hydrogen is supplied to the anode 5 from the hydrogen supply section 50 and air is supplied to the cathode 4 from the air supply section 60 during the electricity generation.

At this time, as shown in FIG. 1, it is determined that the air pressure in the fuel gas passage 7c in the cathode 4 is P1 and the hydrogen pressure in the fuel gas passage 7c in the anode 5 is P2. After the stoppage of the electricity generation of the fuel cell stack 100, hydrogen is supplied to the anode 5 through the hydrogen supply section 50 and air is supplied to the cathode 4 through the air supply section 60 in order to make a pressure difference (P1−P2).

For example, when it is so set that the hydrogen pressure P2 in the anode 5 is greater than the air pressure P1 in the cathode 4, namely, the relationship (P1<P2) is made, the residual water is moved from the anode 5 to the cathode 4 through the polymer proton exchange membrane 1, and accumulated in the cathode 4. It is thereby possible to drain the residual water accumulated through the water collecting groove 7g in the separator 7a in the cathode 4. In this case, it is acceptable to form the water collecting groove 7g only in the separator 7a of the cathode 4.

On the contrary, when the relationship (P1>P2) is made, because the residual water is moved from the cathode 4 to the anode 5 through the polymer proton exchange membrane 1, and accumulated in the anode 5. In this case, it is possible to drain the residual water accumulated through the water collecting groove 7g of the separator 7b in the anode 5. In this case, it is acceptable to form the water collecting groove 7g only in the separator 7b of the anode 5.

How to make the pressure difference between the air pressure P1 in the cathode 4 and the hydrogen pressure P2 in the anode 5 is as follows.

After the stoppage of the electricity generation of the fuel cell stack 100, only one of gas supply valves mounted on the fuel gas passages for air and hydrogen is open in order to adjust the amount of fuel gas supply by a regulator. In this case, the pressure of the fuel gas supplied by opening the valve mounted on the fuel gas passage is only increased.

### Other Embodiments

In the above embodiment described above, one water collecting groove is formed per separator in the fuel cell 10, it is also acceptable to form plural water collecting grooves in each separator.

Further, although the piezo actuator 25 and the thermo-wax 26 are used as the actuator capable of changing the pressure of the pressure fastening means, the present invention is not limited by those.

For example, it is acceptable to use an actuator operating by electromagnetic force. Further, in order to change the pressure force of the pressure fastening means, it is acceptable to use oil pressure source and air pressure source mounted on a vehicle. This case requires detecting the temperature and voltage of the fuel cell stack 100 by using a temperature sensor and a voltage sensor in order to detect the decrease of the temperature of the fuel cell stack 100 and the output voltage of the fuel cell stack 100. The pressure force to be supplied to the fuel cell 10 forming the fuel cell stack 100 is controlled based on the detection result.

The present invention is not limited by this configuration and arrangement pattern of the fuel gas passages 7c shown in FIG. 2.

As describe above in detail, in a polymer electrolyte fuel cell (PEFC) and system having the PEFC, the inventors of the present invention have noticed the arrangement of the plural fuel cells 10 in the fuel cell stack 100 such as PEFC in which each of the plural fuel cells 10 is arranged vertically to its stacked direction (or vertical direction), where each fuel cell 10 has the lamination body made of the catalyst layer 2, the diffusion layer 3, and the polymer proton electrolyte membrane 1. The polymer proton electrolyte membrane 1 is sandwiched by a pair of the bodies, each of which is made of the catalyst layer 2 and the diffusion layer 3. The lamination body made of the polymer proton electrolyte membrane 1, the anode 5 and the cathode 4 is sandwiched by a pair of the separators 7a and 7b. Further, the water collecting grooves 7g for collecting residual water remained in the diffusion layer 3 of the fuel cell 10 are formed in the inner surface of one or both the separators 7a and 7b of each fuel cell 10. The water collecting groove 7g is not jointed to the fuel gas passages 7c and formed in the lower part than the end of the diffusion layer 3 in the lamination body (1, 4, 5) in each fuel cell 10. It is acceptable to change in design the various components other than the water collecting grooves 7g in the fuel cell 10, the fuel cell stack 100, and the fuel cell system according to various demands.

Further, according to the present invention, the water collecting groove 7g is formed in the inner surface of the separator 7a faced to at least the cathode 4. As has been prescribed, the residual water is more produced in the diffusion layer 3 of the cathode 4 than in the diffusion layer 3 of the anode 5, it is possible to exhaust the residual water in the fuel cell 10 efficiently by the water collecting groove 7g formed in the inner surface of the separator 7a faced to at least the cathode 4.

Still further, according to the present invention, the surface 7e of the land area 7d formed between the groove 7g and the fuel gas passage 7c adjacent to the groove 7g, faced to the diffusion layer 3 in each of the cathode 4 and the anode 5 is more separated in position than the surface 7e formed between the adjacent fuel gas passages 7c from the polymer proton electrolyte membrane 1, as shown in FIG. 1.

According to the above configuration, because the surface pressure at the surface 7e on the water collecting groove 7g in each separator for pressing the diffusion layer 3 is set to a small value, it is thereby possible to easily pass the residual water in the diffusion layer 3 to the water collecting groove 7g, that is, easy drop of the residual water to the water collecting groove 7g can be achieved.

Moreover, according to the present invention, the diffusion layer 3 is made of one of carbon fiber cloth and carbon fiber nonwoven cloth, and the carbon fibers are approximately aligned on average toward a direction to the water collecting groove 7g.

In the configuration of the fuel cell stack 100 made of the fuel cells 10 stacked, the residual water is easily moved to the water collecting groove 7g along the aligned direction of the fibers. This can promote the easy drop of the residual water to the water collecting groove 7g.

Still further, according to the present invention, the water exhaust manifold 80 configured to drain water accumulated in the water collecting groove 7g is mounted on the fuel cell stack 100. Through the water exhaust manifold 80, the water accumulated in the water collecting groove 7g in each fuel cell 10 is easily exhausted to the outside of the fuel cell stack 100.

Furthermore, according to the present invention, the pressure fastening means 20 is mounted on the fuel cell stack 100. The pressure fastening means 20 is configured to press and fasten the fuel cells 10 stacked toward the stacked direction and capable of applying a smaller pressure force to the stacked fuel cells 10 in the stoppage of the electricity generation than that during the electrical power generation.

It is thereby possible to release the surface pressure to be applied to the diffusion layer 3 by the separators 7a and 7b when the electricity generation is stopped and to promote the water drop of the residual water in the diffusion layer 3 to the water collecting groove 7g.

Moreover, according to the present invention, the pressure fastening means 20 is equipped with the actuator 25. The length of the actuator 25 when a voltage is applied thereto becomes longer than that when no voltage is applied thereto. The magnitude of the pressure force by the pressure fastening means 20 is decreased according to decreasing the length of the actuator 25.

The actuator 25 is capable of pressing and fastening each of the stacked fuel cell 10 by using the output voltage of the fuel cell stack 100. After the stoppage of the electricity generation, because the length of the actuator 25 becomes longer than that during the electricity generation, the actuator 25 can release its pressure force to the fuel cells 10. The pressure fastening means 20 equipped with the actuator 25 is capable of promoting the drop or movement of residual water in the diffusion layer 3 to the water collecting groove 7g by properly releasing the pressure force to be applied to the fuel cells 10 without any monitoring the output voltage of the fuel cell stack 100.

Further, according to the present invention, the pressure fastening means 20 is equipped with the actuator 26. The volume of the actuator 26 is decreased according to falling a temperature of the actuator 26, and the actuator 26 decreases the magnitude of the pressure force to be applied to the fuel cells 10 by decreasing the volume there.

In general, the fuel cell stack 100 performs the electricity generation at a high temperature and the temperature thereof is decreased gradually after the stoppage of the electricity generation. By using this phenomenon of the fuel cell stack 100, because the volume of the actuator 26 is decreased after the stoppage of the electricity generation when compared with that during the electricity generation, it is possible to release the pressure force to be applied to the fuel cells 10 by the actuator 26.

The pressure fastening means 20 equipped with the actuator 26 is capable of promoting the residual water drop in the diffusion layer 3 to the water collecting groove 7g by properly releasing the pressure force to be applied to the fuel cells 10 without any monitoring the temperature of the pressure fastening means 20.

Still further, the present invention provides the fuel cell system equipped with the fuel cell stack 100, the hydrogen supply section 50, the air supply section 60. The hydrogen supply section 50 supplies hydrogen gas to the anode 5 in each fuel cell 10 forming the fuel cell stack 100. The air supply section 60 supplies air to the cathode in each fuel cell 10 forming the fuel cell stack 100. The electrical power generation is performed by electrochemical reaction of oxygen involved in the air and the hydrogen gas supplied to the fuel cells 10 in the fuel cell stack 100.

Thus, the present invention can provide the fuel cell system equipped with the fuel cells 10 forming the fuel cell stack 100 having the features described above.

Furthermore, according to the fuel cell system of the present invention water produced in each fuel cell 10 is collected by a pressure difference between the fuel gases such as hydrogen and air to be supplied to the anode 5 and the cathode 4 after the stoppage of the electricity generation in the fuel cell stack 100 so that the water flows or drops from a high pressure gas side to a low pressure gas side.

Based on the above feature, it is possible to form the water collecting groove in the inner surface of at least one of the separators 7a and 7b because the residual water is collected only to the water collecting groove 7g formed in at least one of the anode 5 and the cathode 4.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalent thereof.

What is claimed is:

1. A fuel cell stack comprising a plurality of fuel cells stacked in series along a direction vertical to a main surface of each fuel cell, and
each fuel cell comprising: an anode; a cathode; an electrolyte membrane sandwiched between the anode and the cathode; and a pair of the separators by which the anode, the cathode, and the electrolyte membrane are sandwiched,
wherein a water collecting groove, configured to collect water generated by electrochemical reaction in the fuel cell, is formed in a bottom area of an inner surface of the separator in each fuel cell, and the bottom of the water collecting groove is formed lower in position than a bottom end of each of the electrolyte membrane, the anode, and the cathode.

2. The fuel cell stack according to claim 1, wherein the water collecting groove is formed in the inner surface of at least the separator faced to the cathode.

3. The fuel cell stack according to claim 1, wherein the electrolyte membrane is made of a polymer proton exchange membrane,
the anode comprises a diffusion layer and a catalyst layer, the catalyst layer being contacted to the polymer proton exchange membrane, and
the cathode comprises a diffusion layer and a catalyst layer, the catalyst layer being contacted to the polymer proton exchange membrane.

4. The fuel cell stack according to claim 3, wherein fuel gas passages are formed in the inner surface of each of the separators faced to the anode and the cathode, and adjacent fuel gas passages are separated to each other through a land area formed between adjacent fuel cell passages, and the water collecting groove is not joined to the fuel gas passage by the land area.

5. The fuel cell stack according to claim 4, wherein a distance measured from the electrolyte membrane to the surface of the land area formed between the water collecting groove and the fuel gas passage adjacent to the water collecting groove in each separator is longer than a distance measured from the electrolyte membrane to the surface of the land area formed between the adjacent fuel gas passages.

6. The fuel cell stack according to claim 3, wherein the diffusion layer is made of one of carbon fiber cloth and carbon fiber nonwoven cloth, and the carbon fibers are approximately aligned toward a direction to the water collecting groove.

7. The fuel cell stack according to claim 4, wherein the diffusion layer is made of one of carbon fiber cloth and carbon fiber nonwoven cloth, and the carbon fibers are approximately aligned toward a direction to the water collecting groove.

8. The fuel cell stack according to claim 1, further comprising a water exhaust manifold configured to drain water accumulated in the water collecting grooves.

9. The fuel cell stack according to claim 3, further comprising a water exhaust manifold configured to drain water accumulated in the water collecting grooves.

10. The fuel cell stack according to claim 1, further comprising a pressure fastening means configured to press and fasten the fuel cells stacked toward the stacked direction, and capable of applying a larger pressure force to the stacked fuel cells during the electricity generation than in the stoppage of the electrical power generation.

11. The fuel cell stack according to claim 3, further comprising a pressure fastening means configured to press and fasten the fuel cells stacked toward the stacked direction, and capable of applying a larger pressure force to the stacked fuel cells during the electricity generation than in the stoppage of the electrical power generation.

12. The fuel cell stack according to claim 10, wherein the pressure fastening means comprises an actuator, and a length of the actuator on applying a voltage thereto is longer than a length of the actuator on not applying a voltage thereto, and the magnitude of the pressure force by the pressure fastening means is decreased according to decrease of the length of the actuator.

13. The fuel cell stack according to claim 11, wherein the pressure fastening means comprises an actuator, and a length of the actuator on applying a voltage thereto is longer than a length of the actuator on not applying a voltage thereto, and the magnitude of the pressure force by the pressure fastening means is decreased according to decrease of the length of the actuator.

14. The fuel cell stack according to claim 10, wherein the pressure fastening means comprises an actuator, and a volume of the actuator is decreased according to falling a temperature of the actuator, and the magnitude of the pressure force by the pressure fastening means is decreased by decreasing the volume of the actuator.

15. The fuel cell stack according to claim 11, wherein the pressure fastening means comprises an actuator, and a volume of the actuator is decreased according to falling a temperature of the actuator, and the magnitude of the pressure force by the pressure fastening means is decreased by decreasing the volume of the actuator.

16. A fuel cell system comprising:
the fuel cell stack according to claim 1;
a hydrogen gas supply section configured to supply hydrogen gas to the anode of the fuel cells forming the fuel cell stack; and
an air supply section configured to supply air to the cathode of the fuel cells forming the fuel cell stack,
wherein the electrical power generation is performed by electrochemical reaction of oxygen involved in the air and the hydrogen gas supplied to the fuel cells in the fuel cell stack.

17. The fuel cell system according to claim 16, wherein water produced in each fuel cell is collected by a difference between the pressures of the gases to be supplied to the anode and the cathode after stoppage of the electrical power generation in the fuel cell stack so that the water flows from a high pressure gas side to a low pressure gas side.

18. A fuel cell comprising:
an electrolyte membrane made of a polymer proton exchange membrane sandwiched between an anode and a cathode;
the anode made of a diffusion layer and a catalyst layer;
the cathode made of a diffusion layer and a catalyst layer; and
a pair of separators by which a lamination body made of the anode, the electrolyte membrane, and the cathode laminated is sandwiched, and at least one separator having a water collecting groove, configured to collect water generated by electrochemical reaction, formed in a bottom area of the inner surface of the separator and lower in position than a bottom end of each of the electrolyte membrane, the anode, and the cathode.
